(19) United States
(12) Patent Application Publication
(10) Pub. No.: US 2006/0176207 A1
(43) Pub. Date: Aug. 10, 2006

(54) Electronic operating system

(76) Inventors: Martin Elixmann, Aachen (DE); Thomas Falck, Aachen (DE); Henning Maass, Aachen (DE); Klaus Weidenhaupt, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/546,406

(22) PCT Filed: Feb. 16, 2004
(86) PCT No.: PCT/IB04/00447

§ 371 Date: Aug. 19, 2005

(30) Foreign Application Priority Data
Feb. 25, 2003 (EP) 03100458.3

(51) Int. Cl. G08C 19/12

(52) U.S. Cl. 341/176; 340/825.72

(57) ABSTRACT

The invention relates to an electronic operating system comprising at least one functional apparatus (10) and at least one remote control unit (11). To implement the possibilities of interaction in a more intensive, yet more user-friendly way, the remote control unit (11) and the functional apparatus (10) co-operate with each other by means of automatic intercommunication in such a way that, at any instant during interaction with the operating system, exactly those interaction possibilities that correspond to the user's readiness for interaction can be indicated and offered for demand to the user.

The invention relates to an electronic operating system comprising at least one functional apparatus and a wireless remote control unit.

Wireless communication techniques are also known for operating apparatuses via remote control units. Wireless connections, for example, in accordance with the Bluetooth standard provide the possibility of operational contact between all apparatuses that are ready for communication in so far as these apparatuses are within the relevant radio transmission range. In this case, a network and apparatus address is provided which, however, does not inform the user about the possibilities of interaction.

Also Local Area Networks in accordance with the IEEE 802.11 standard support, in the mode without infrastructure, the direct network-linking of apparatuses to one ad hoc network. Also in this case, the user is not informed about the offered possibilities of interaction with the other participants in the ad hoc network.

Many mobile apparatuses and stationary apparatuses in entertainment electronics and in the personal computer range nowadays employ wireless connection techniques so that they can be incorporated in a digital ad hoc communication network.

On this basis, it is an object of the present invention to implement the possibilities of interaction in a more intensive, yet more user-friendly way in an electronic operating system of the type described hereinbefore.

According to the invention, the envisaged object in an electronic operating system of the type described hereinbefore is solved by the characterizing features defined in claim 1.

Further advantageous embodiments of the electronic operating system according to the invention are defined in the dependent claims.

The basic idea of the electronic operating system according to the invention is that the remote control unit and the functional apparatus co-operate by way of automatic intercommunication in such a way that the operation is automatically applicable to the requirements imposed by the user.

In the simplest case, the possibilities of interaction are represented by a quantity (M1, M2, . . . , Mn) of offers, also referred to as the supply profile, and the readiness for interaction is represented by a quantity (W1, W2, . . . , Wm) of wishes, also referred to as the demand profile.

If there is no correspondence between possibilities of interaction and readiness for interaction, the functional apparatus is not perceived.

Therefore, only functional apparatuses are perceived that offer a suitable interaction possibility, i.e. the operating system filters out unsuitable functional apparatuses. In a functional apparatus detected as being suitable, the unsuitable interaction possibilities are filtered out.

In a further advantageous embodiment, a plurality of functional apparatuses automatically communicates within the transmission range with a remote control unit via transmitting/receiving interfaces.

In a further advantageous embodiment, an apparatus may be simultaneously both a functional apparatus and a remote control unit. Operating parameters and/or operating functions are interchangeable.

This means that functional apparatuses and the remote control unit communicate with each other automatically and via a wireless connection about available functions so that they can automatically offer the desired functions to the user.

In a further advantageous embodiment, the demand profile can be automatically transmitted in a wireless way to the functional apparatus in which it is matched with the supply profile and the matching result can be indicated and transmitted back to the remote control unit.

It is also advantageous that the supply profile can be transmitted in a wireless way from the functional apparatus to the remote control unit in which it can be matched with the demand profile.

When approaching a plurality of functional apparatuses or one functional apparatus and the remote control unit, automatic matching is generated within the functional apparatuses, thereby automatically matching the operation demands with the possible supply of operation functions via a radio connection. In this respect, it is important that this is effected automatically and is substantially hidden from the operator. This considerably enhances the ease of operation.

In a further advantageous embodiment, all functional apparatuses and remote control units and components belonging to the system are provided with means that are suitable for transmission and reception in a uniform communication standard so as to realize this intercommunication.

Furthermore, each functional apparatus and each remote control unit is provided with a microcomputer which is data-technically connected to a memory in the apparatus as well as to the intercommunication interface.

Furthermore, the supply of functions by the functional apparatus is exclusively limited to those functions that are desired and/or requested by the user.

Advantageously, all functional apparatuses and components belonging to the system are provided with uniform means that are suitable for transmission and reception so as to realize this intercommunication.

Each functional apparatus is provided with a microcomputer which is data-technically connected to a memory in the apparatus as well as to the intercommunication interface.

The supply of functions by the functional apparatus is exclusively limited to those functions that are desired and/or requested by the user. In this way, an operation which is considerably different from the known operating mode is achieved.

In known operating systems, the user or operator has trouble switching through a function-selected menu until he reaches the function or setting that he wishes to set or request.

This is different in the operating system according to the invention. Due to the automatic intercommunication between the functional apparatuses and the remote control unit, the actually available functions and settings are offered in conformity with the user's operating wishes or demands. The quantity of possible apparatus-specific functions is a quantity M1 and the setting functions desired by the user are another quantity W1.

Within the system, the interface quantity is formed from M1 and W1 and it is only this quantity that is offered to the user. This leads to a hitherto unparalleled ease of operation because the capacity of the system and the operating demands are automatically matched with each other.

When incorporating a new functional apparatus, an elaborate study of instructions for use is thus no longer necessary, but via the interaction interfaces according to the invention, the new functional apparatus brought within range of the other functional apparatuses will automatically exchange data about functions and settings which are available in the system with those data that are frequently requested by the user and will thus logically interconnect them. It is therefore not necessary to study instructions for use of the new apparatus. The apparatus “finds its place” automatically and offers “its” functions to the user.

These and other aspects of the invention are apparent from and will be elucidated with reference to the embodiments described hereinafter.

In the drawings:

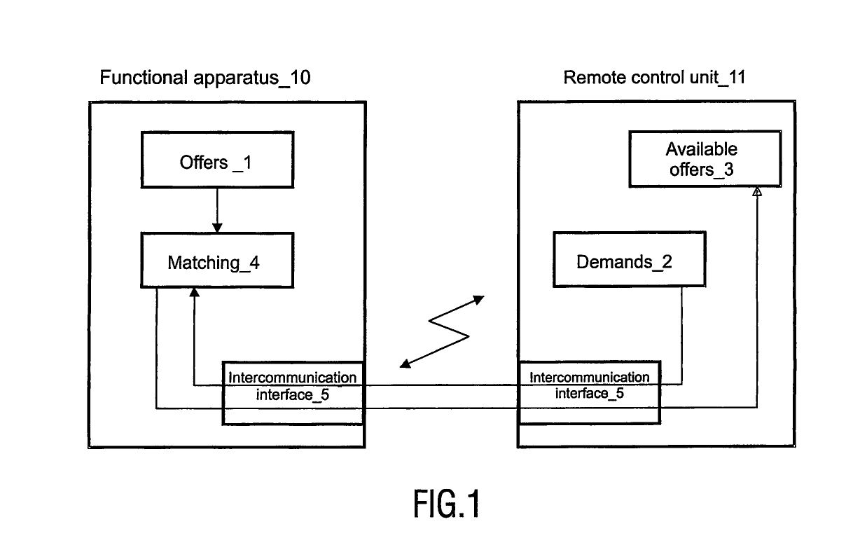

FIG. 1 shows the fundamental structure of the operating system according to the invention and the intercommunication between a functional apparatus and a remote control unit.

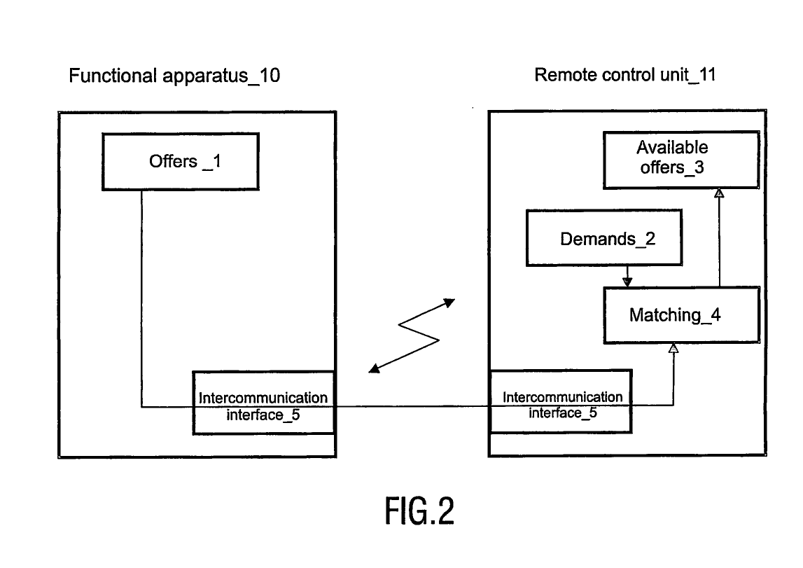

FIG. 2 shows an alternative structure of the operating system according to the invention and the intercommunication between a functional apparatus and a remote control unit.

FIG. 1 shows the fundamental logical structure of an operating system according to the invention. It comprises a functional apparatus 10 and an operating device in the form of, for example, a remote control unit 11. Within the specific functional apparatus 10, functions and properties are technically implemented in the form of offers 1. These properties are also stored as “available functions” within the functional apparatus. The operating function demands 2 are stored in the remote control unit 11.

To this end, the functional apparatus 10 and the remote control unit 11 shown diagrammatically have storage means in which the described data are stored, as well as a microcomputer which computes the data and converts them into functions and, possibly, control signals.

Furthermore, the microcomputer is also connected to an intercommunication interface 5 via which the functional apparatus 10 can establish wireless contact with the operating unit or the remote control unit 11.

Expected operation function demands 2 are now taken into account for the available functions of the apparatus. As already described hereinbefore, a characteristic feature of the invention is that the functions offered by the apparatus are automatically copied onto the functions expected by the operator.

As soon as the remote control unit 11 comes within the radio range of the functional apparatus 10, it automatically sends the user's demands to the functional apparatus 10 via the intercommunication interface 5. The functional apparatus 10 includes a matching device 4 which forms the cut-set from the received user demands and the available functions 1 of the apparatus. The matching result is the quantity of user-adapted offers by the functional apparatus. If the cut-set is not empty, the functional apparatus 10 transmits the available offers thus determined in a wireless way to the remote control unit 11 via the intercommunication interface 5. The remote control unit 11 stores the received available offers 3 and indicates them to the user as interaction possibilities that can be requested by the user.

The user or operator now no longer needs to take the trouble of working his way through instructions for use, but the functions he demands or expects are now automatically offered on demand.

This system can be used for audio apparatuses, television apparatuses, personal computers, mobile phones, etc.

Also a plurality of functional apparatuses may be incorporated in such a system with a remote control unit.

Moreover, combined apparatuses are possible which combine both the functionality of a functional apparatus and that of a remote control unit.

FIG. 2 shows a further advantageous embodiment of the operating system in which it is not necessary for the user to transfer his demands to the functional apparatus, thus avoiding that third parties are informed of his demands.

In contrast to FIG. 1, the remote control unit 11 comprises a matching device 4. When the functional apparatus 10 comes within the transmission range of the remote control unit 11, it provides this unit in a wireless way, and via the intercommunication interface 5, with a list including the fundamentally supported functions (offers) 1 of the functional apparatus 10. In the remote control unit 11, the received offers are compared with the user's demands 2 in the matching device 4. The matching results are the user-adapted available offers of the functional apparatus. The remote control unit 11 stores the available offers 3 thus obtained and indicates them to the user as interaction possibilities that can be requested by the user.

1. An electronic operating system comprising at least one functional apparatus (10) and at least one remote control unit (11), in which the remote control unit and the functional apparatus co-operate with each other by means of automatic intercommunication and automatic profile matching in such a way that, at any instant during the interaction with the operating system, exactly those interaction possibilities that correspond to the user's readiness for interaction can be indicated and offered for demand to said user.

2. An electronic operating system as claimed in claim 1, wherein a plurality of functional apparatuses (10) automatically communicates within the transmission range with a remote control unit (11) via transmitting/receiving interfaces (5).

3. An electronic operating system as claimed in claim 2, wherein an apparatus may be simultaneously both a functional apparatus and a remote control unit.

4. An electronic operating system as claimed in claim 2, wherein the demand profile can be automatically transmitted in a wireless way to the functional apparatus in which it is matched with the supply profile, and wherein the matching result can be indicated and transmitted back to the remote control unit.

5. An electronic operating system as claimed in claim 2, wherein the supply profile can be transmitted in a wireless way from the functional apparatus to the remote control unit in which it can be matched with the demand profile.

6. An electronic operating system as claimed in claim 1, wherein all functional apparatuses (10), remote control units (11) and components belonging to the system are provided with means (5) that are suitable for transmission and reception in a uniform communication standard so as to realize said intercommunication.

7. An electronic operating system as claimed in claim 1, wherein each functional apparatus (10) and each remote control unit (11) is provided with a microcomputer which is data-technically connected to a memory in the apparatus as well as to the intercommunication interface (5).

8. An electronic operating system as claimed in claim 1, wherein the supply of functions by the functional apparatus is exclusively limited to those functions that are desired and/or requested by the user.
